(19) United States
(12) Patent Application Publication
(10) Pub. No.: US 2004/0166219 A1
(43) Pub. Date: Aug. 26, 2004

(54) Biscuit for frozen confectionery

(76) Inventor: Holger Werner Justi, Bangkok (TH)

Correspondence Address: WINSTON & STRAWN, PATENT DEPARTMENT, 1400 L STREET, N.W., WASHINGTON, DC, 20005-3502, US

(21) Appl. No.: 10/761,614

(22) Filed: Jan. 20, 2004

Related U.S. Application Data
(63) Continuation of application No. PCT/EP02/06590, filed on Jun. 13, 2002.

(30) Foreign Application Priority Data
Aug. 9, 2001 (EP) EP 01203016.9

(51) Int. Cl. A21D 10/00

(52) U.S. Cl. 426/549

(57) ABSTRACT

Crisp and crunchy reconstituted biscuit composed of fragments of baked biscuit, agglomerated within a binder comprising at least one carbohydrate and fat, the biscuit having the characteristic feature of preserving its crunchiness during storage at a negative temperature. Also, composite frozen confectioneries that include a biscuit and a frozen confectionery mass in contact therewith. The frozen confectionery thus obtained has the advantage of the contrast in texture between the creaminess of the frozen confectionery mass and the crunchiness of the biscuit, even after a long storage at freezing temperature. Finally, a process for preparing such a biscuit.

### CROSS-REFERENCE TO RELATED APPLICATIONS

This application is a continuation of International application PCT/EP02/06590 filed Jun. 13, 2002, the entire content of which is expressly incorporated herein by reference thereto.

### BACKGROUND ART

The present invention relates to the field of biscuit manufacture and more particularly to the field of biscuit manufacture adapted for use in composite frozen confectionery products in which a mass of frozen confectionery is combined with the biscuit.

Numerous products of the frozen confectionery type comprising biscuit exist. They may be, for example, “cones” in which ice cream is contained in a conical wafer. They may also be frozen cakes comprising alternate layers of ice cream, sorbet and biscuit.

The biscuit generally used is a relatively dry, brittle and crunchy biscuit of the wafer type, for example. Such a type of biscuit is particularly desirable because it exhibits good crunchiness and considerable ease of forming. After assembling the ice cream and the biscuit, the product is stored in the frozen state. However, during this storage, the biscuit exhibits a tendency towards a high uptake of moisture, both from the ice cream and from the external environment. Such a moisture uptake is damaging to the organoleptic qualities of the biscuit, the latter rapidly becoming soft, spongy and rubbery. A possible solution to this problem consists in applying a fat-based barrier layer between the biscuit and the ice cream. However, the problem is only partially solved because the uptake of moisture from the outside is not avoided. Furthermore, the presence of such a fat layer, which is solid at deep-freezing temperatures, is poorly perceived from the organoleptic point of view because it does not melt simultaneously with the ice cream and fatty residues remain in the mouth.

As regards the shape of the wafer-type biscuits, it is most often rectangular or square, and shapes which are oval, round, elliptical or which have an irregular or cut-out contour are very difficult or even impossible to obtain both because of the technology used during the manufacture of such products and their brittleness. Moreover, although these wafers are quite suitable for the production of various three-dimensional shapes such as cones or hemispheres, they need to be heated in order to ensure their malleability so as to adopt the shapes of the mold. Apart from the fact that it is expensive, such a step for shaping in the hot state complicates the process for manufacturing frozen confectionery products because it requires cooling of the hot, shaped wafer in order to avoid heat shock with the mass of frozen confectionery during subsequent filling or contacting steps.

Thus, there is a need for a biscuit which can be easily formed in the cold state into any flat or three-dimensional shape, which is crunchy and crisp, which does not disintegrate during handling and which, when used in combination with ice cream to produce a frozen confectionery, preserves such qualities during and after storage at the customary freezing temperatures. The present invention now satisfies this need and resolves the problems or the prior art.

### SUMMARY OF THE INVENTION

The present invention relates to a reconstituted biscuit composed of fragments of baked biscuit, agglomerated within a binder comprising at least one carbohydrate and a fat, the biscuit having the characteristic feature of preserving its physical integrity, its shape and its crunchiness during stages of handling and/or of storage at negative or freezing temperatures, i.e., during processing or storage at temperatures below 0° C.

The present invention also relates to a composite frozen confectionery product comprising a biscuit according to the invention in combination with a mass of frozen confectionery in contact with this biscuit. Thus, by virtue of the formulation of the biscuit according to the invention, the resulting composite frozen confectionery product has the advantage of contrast in texture between the creamy and the melting of the mass of frozen confectionery and the crunchiness and the crispness of the biscuit, even after a long term storage at freezing temperatures, that is to say temperatures of less than −8° C., preferably less than −10° C.

Other embodiments of the invention relate to a process for preparing such biscuits and the biscuits formed thereby.

### DETAILED DESCRIPTION OF THE PREFERRED EMBODIMENTS

The expression “fragments of biscuit,” as used herein, is understood to mean particles of baked biscuit that are obtained after breaking of traditional baked biscuits. These particles may be provided in the form of more or less coarse spheres. The random distribution of the particles is such that at least about 60% of these particles have a mean diameter of between about 2 and 3 mm, and preferably at least 90% of these particles have a mean diameter of between about 1 and 3 mm.

The expression “mass of frozen confectionery,” as used herein, is understood to mean a dairy product-based frozen composition such as ice cream or frozen yogurts, but also sorbets or water ice.

Thus, by virtue of the presence of the binder comprising at least one carbohydrate and fat within the biscuit according to the invention, the latter preserves its crunchiness throughout storage at low temperature in spite of the absence of a hydrophobic barrier layer between the ice cream and the biscuit. Indeed, the fragments of biscuit which provide the crunchiness of the biscuit preserve this crunchiness by virtue of the fat from the binder. This fat thus acts as a barrier to moisture and individually protects each fragment of biscuit from the migration of water both from the ice cream and from the ambient atmosphere. This fat, which is solid at freezing temperatures, makes it possible to isolate the fragments of biscuit from any regain of moisture from the ice cream or from the external environment. Furthermore, because it does not constitute a coating having a notable thickness, it is imperceptible during consumption of the biscuit, which avoids the problem of a fatty mouth feel. These biscuit particles thus trapped in the total mass of the reconstituted biscuit of the assembly formed with the ice cream confer crunchiness and crispness on the biscuit in its entirety.

The carbohydrate entering into the composition of the binder may be sucrose, maltodextrin or glucose syrup, used alone or as a mixture. The binder may comprise from 20 to 40% of fat, 50 to 75% of carbohydrate and 0.01 to 5% of at least one emulsifier.

In the process of manufacture of these biscuits, the present invention includes the following steps:

heating a mixture comprising 50 to 75 parts of a fat that is solid at room temperature and 20 to 40 parts of at least one carbohydrate at a temperature and for a period of time sufficient to ensure melting of the fat,

mixing 60 to 90 parts of the resulting heated mixture with 10 to 30 parts of biscuit particles,

cooling the mixture of fat, carbohydrate and biscuit particles, with stirring, to a temperature less than the melting point of the fat,

preparing a syrup by heating, with stirring, a mixture comprising 50 to 80 parts of at least one carbohydrate, 20 to 50 parts of water, 2 to 10 parts of a fat which is solid at room temperature and 0.01 to 5 parts of at least one emulsifier, at a temperature and for a period of time sufficient to ensure dissolution and emulsification of the ingredients,

cooling the syrup to a temperature that is less than the melting point of the fat in the mixture that includes the biscuit particles,

combining 40 to 80 parts of the mixture that includes the biscuit particles with 20 to 60 parts of the cooled syrup to obtain a malleable mass,

forming the mass into a desired shape of the biscuit, and

hardening the final biscuit by evaporating water contained therein so as to obtain a reconstituted biscuit having a final moisture level of between 1 and 5%.

Thus, in a first stage, a coating mixture is prepared which is based on fat which is solid at room temperature and carbohydrate which will serve to coat the biscuit particles. This coating mixture thus comprises between 50 and 75% of a fat that is solid at room temperature and 20 to 40% of carbohydrate. The fat in question may be a hydrogenated or partially hydrogenated vegetable oil such as a hydrogenated coconut oil, for example. The fat may thus be heated to a temperature greater than its melting point, for example in the region of 45-50° C., and the carbohydrate then added, before the whole mixture is further mixed and homogenized, e.g., in a roller-type mixer.

Subsequently, biscuit particles are added to the homogenized coating mixture in an amount of 60 to 90 parts of biscuit particles per 10 to 30 parts of coating mixture. The mixture obtained is then slowly cooled, with stirring, to a temperature less than the melting point of the fat in the coating mixture.

In parallel, a syrup is prepared by heating, to a temperature of the order of 80 to 120° C., a mixture comprising 50 to 80 parts of carbohydrate which may be crystal sucrose, 20 to 50 parts of water, 2 to 10 parts of a fat which is solid at room temperature and 0.01 to 5% of at least one emulsifier. The fat which is solid at room temperature used for the preparation of this syrup may be identical to that entering into the composition of the coating mixture. The emulsifier may be monoglycerides, diglycerides, or lecithins, used alone or as a mixture. The syrup is mixed and homogenized so as to ensure the emulsification of the ingredients. The syrup may then be cooled to around room temperature, that is to say 20 to 30° C., so as to be at a temperature less than the melting point of the fat in the syrup and the coating mixture.

Finally, the coating mixture comprising the biscuit particles and syrup are mixed in a ratio of 40 to 80 parts of mixture to 60 to 20 parts of syrup.

The mixture obtained is homogenized so as to form a sort of malleable lump which can be formed at room temperature into any desired shape. This lump has a moisture of the order of 5 to 15%. The reconstituted biscuits obtained may then be left to one side to cool and then stored in carton packaging.

The forming of the biscuit mass may be carried out at room temperature. This forming may be carried out by extrusion, molding or even laminating. Preferably, the forming is carried out by pressing the mixture in a mold having the desired shape. It may thus be a parallepipedal mold which is filled with the biscuit mass which is then compacted and compressed so as to compress and agglomerate the particles and thus adopt the shapes and the details of the mold. By virtue of the malleability of the biscuit mass according to the invention, diverse and varied shapes may be obtained such as triangles, discs, ovals or others as desired. Furthermore, this forming stage may also be carried out using a three-dimensional mold; the biscuit mass is introduced into a hollow mold of desired shape and a complementary part forms the biscuit by compression. This may thus be a pointed die compressing the mass in a conical mold in order to form a cone-type biscuit or a round die compressing the mass in question in a hemispherical mould so as to form a sort of hemispherical shell made of biscuit mass. Once a flat shape has been produced, it can also be formed or manipulated into the final shape of the product. For example, the biscuit mass can be manipulated into the shape of a cylinder which may be filled with a mass of frozen confectionery to form the final product. The reconstituted biscuit formed may have the typical thickness of a traditional biscuit, that is to say about 2 to 20 mm and preferably about 3 to 10 mm. The thickness of the reconstituted biscuit is not necessarily uniform and may vary within a defined range; thus it is within the scope of the invention to provide a biscuit having a hemispherical shape with a base that is thicker than the walls or in other configurations as desired.

The biscuit mass may instead be pressed in a conical mold using a die in order to obtain a biscuit having the shape of a cone which will serve as a receptacle for the frozen mass of frozen confectionery. The shaping may also be carried out by extrusion or lamination of the biscuit mass in the form of plates or bands which may be cut to the desired sizes and thus serve for the production of frozen sandwiches comprising a portion of ice cream between two biscuits. The bands for a biscuit may be cut using a hollow punch so as to obtain attractive shapes, such as discs, ovals with sinuous edges, or even figurines. Finally, the biscuit mass may also be compacted in a mold of any shape so as to adopt the shapes thereof, and then filled with ice cream to form the composite.

After the forming stage, the biscuit can then be subjected to a more or less extensive drying stage so as to give it maximum crunchiness, which corresponds to a final moisture in the reconstituted biscuit of the order of 1 to 5%. The drying may be carried out by pressing the biscuit formed in a hot-air drying tunnel. Typical drying conditions include a temperature of the order of 40 to 150° C. for a period on the order of 10 to 60 minutes. The drying stage serves in the first place to bring about the final hardening of the reconstituted biscuit but can also contribute to the development of its flavor. Indeed, during this drying stage, the residual water is partially evaporated, the carbohydrate of the binder crystallizes and the whole mass hardens, conferring on the final product its crunchy and crisp texture. Also, by virtue of Maillard reactions which may occur during this drying stage, additional flavors may also develop.

The biscuit mass according to the invention has the advantage of being capable of being formed into practically any shape, this being at room temperature using conventional industrial equipment such as a laminator, an extruder, hollow punches or simple moulds. Such a biscuit has the advantage, in addition to preserving its crunchiness, of being easy to form at room temperature, which is more economical and furthermore does not pose the problem of a possible heat shock and avoids a cooling stage, unlike what occurs with wafers. Furthermore, the biscuit mass according to the invention may be formed continuously or endlessly without prior heating.

The reconstituted biscuit according to the present invention, by virtue of its properties of crunchiness and by virtue of the binder coating the particles of baked biscuit, is thus particularly well suited to frozen confectionery applications in which this biscuit is combined with a frozen confectionery mass such as ice cream. The present invention therefore also relates to a composite frozen confectionery comprising a biscuit according to the present invention in contact with a frozen confectionery mass.

The frozen confectionery products according to the invention may thus be provided in the form of conical biscuits, domes or even biscuit tubes which are filled with ice cream and optionally partially or completely coated with chocolate but also frozen sandwiches comprising a mass of frozen confectionery maintained between two biscuits. These confectionery products may also be provided in the form of frozen cakes in which layers of ice cream and biscuit alternate, such as frozen milles-feuilles or frozen sandwiches.

Moreover, the composite frozen confectionery products according to the present invention may also be provided in the form of a frozen confectionery mass comprising biscuit pieces randomly dispersed within it, which makes it possible to provide a pleasant contrast in texture during consumption between the crunchiness of the biscuit and the creaminess of the ice cream, where appropriate.

### EXAMPLES

The following examples further illustrate the preferred embodiments.

### Example 1

### Manufacture of a Biscuit

Preparation of the coating mixture and coating:

66.7 parts of hydrogenated coconut oil are heated to 45° C. and then 33.3 parts of icing sugar are added and the mixture is homogenized.

20 parts of this mixture are mixed with 80 parts of fragments of biscuit of the “petit beurre” type having a mean particle size of 1.5 mm. The whole is cooled to room temperature.

Preparation of the syrup:

A mixture comprising 67 parts of sucrose, 28 parts of water, 5 parts of hydrogenated coconut oil and 0.2 part of saturated fatty acid monodiglyceride is heated to around 106° C. and homogenized so as to ensure good emulsification of the fat/oil/sugar syrup mixture. The syrup obtained is slowly cooled to around 25° C.

Preparation of the lump:

50 parts of syrup are mixed and homogenized with 50 parts of mixture comprising the fragments of biscuit.

Forming:

Aliquots of lump are placed and compressed in rectangular molds with round corners of 10 cm×12 cm and 5 mm deep.

The biscuits formed are demolded and placed on a greased sheet metal plate.

Hardening:

The biscuits formed are dried and hardened by putting them through a pulsed-air oven at 80° C. for 17 minutes.

The biscuits obtained have a residual moisture of 2%, are crunchy and crisp while being easy to handle without risk of breaking.

### Example 2

### Composite Frozen Confectionery

The biscuits as obtained in Example 1 are used to manufacture a frozen confectionery of a vanilla ice cream.

The ice cream is manufactured from the following ingredients:

10 parts of milk powder

0.5 part of emulsifier (CREMODAN®)

0.5 part of vanilla flavor

8 parts of hydrogenated vegetable oil

14 parts of sugar

4 parts of glucose syrup

63 parts of water

The various ingredients are dispersed at 65° C. for 20 minutes. The mixture is then homogenized at 180 bar and then pasteurized at 86° C. for 20 seconds. After cooling to 5° C., the mixture is matured for 24 hours at 4° C. Finally, the mixture is frozen at about −5° C. with an overrun of 100%. The ice cream obtained is hardened in a tub at −30° C. by conventional means.

A vanilla ice cream parallelepiped of 10 cm×12 cm and 2 cm thick is cut and placed in sandwich form between two biscuits (previously cooled to 5° C.) as obtained in Example 1.

The product is stored at −18° C. for 3 months. During consumption, the frozen confectionery biscuit does not disintegrate, does not crack and has characteristics of crunchiness and crispness which are similar to those of the product at the start of storage.

What is claimed is:

1. A reconstituted biscuit composed of fragments of baked biscuit, agglomerated within a binder comprising at least one carbohydrate and a fat, with the biscuit preserving its physical integrity, shape and crunchiness during processing or storage at temperatures below 0° C.

2. The biscuit of claim 1, wherein the binder comprises 20 to 40% of a fat that is a solid at room temperature, 50 to 75% of at least one carbohydrate and 0.01 to 5% of at least one emulsifier.

3. The biscuit of claim 1, wherein the biscuit particles are present as a random distribution such that at least about 60% of the particles have a mean diameter of between about 2 and 3 mm.

4. The biscuit of claim 1, wherein the biscuit particles are present as a random distribution such that at least 90% of the particles have a mean diameter of between about 1 and 3 mm.

5. The biscuit of claim 1, wherein the fat is a hydrogenated vegetable fat.

6. The biscuit of claim 1, wherein the carbohydrate of the binder is sucrose, maltodextrin, or glucose syrup, either used alone or in combination.

7. The biscuit of claim 1, having a final moisture level of between 1 and 5%.

8. A composite frozen confectionery product comprising a biscuit according to claim 1 in contact with a frozen confectionery mass.

9. The composite frozen confectionery of claim 8, wherein the frozen confectionery mass comprises a water ice or a dairy product-based frozen composition.

10. The composite frozen confectionery of claim 8, wherein the biscuit has a desired shape and a final moisture level of between 1 and 5%.

11. A process for manufacturing a biscuit which comprises the following steps:
heating a mixture comprising 50 to 75 parts of a fat that is solid at room temperature and 20 to 40 parts of at least one carbohydrate at a temperature and for a period of time sufficient to ensure melting of the fat,
mixing 60 to 90 parts of the resulting heated mixture with 10 to 30 parts of biscuit particles,
cooling the mixture of fat, carbohydrate and biscuit particles, with stirring, to a temperature less than the melting point of the fat,
preparing a syrup by heating, with stirring, a mixture comprising 50 to 80 parts of at least one carbohydrate, 20 to 50 parts of water, 2 to 10 parts of a fat which is solid at room temperature and 0.01 to 5 parts of at least one emulsifier, at a temperature and for a period of time sufficient to ensure dissolution and emulsification of the ingredients,
cooling the syrup to a temperature that is less than the melting point of the fat in the mixture that includes the biscuit particles,
combining 40 to 80 parts of the mixture that includes the biscuit particles with 20 to 60 parts of the cooled syrup to obtain a malleable mass,
forming the mass into a desired shape of the biscuit, and
hardening the final biscuit by evaporating water contained therein so as to obtain a reconstituted biscuit having a final moisture level of between 1 and 5%.

12. The process of claim 11, wherein the final biscuit is hardened by drying the desired shape of the formed mass with hot air at a temperature of between 40 and 150° C. for 10 to 60 minutes.

13. A reconstituted biscuit made by the process of claim 11.

14. A process for making a composite frozen confectionery product which comprises:
preparing a biscuit according to claim 11;
cooling the biscuit; and
combining the biscuit with a frozen confectionery to form the composite frozen confectionery product.

15. The process of claim 14, wherein the frozen confectionery mass comprises a water ice or a dairy product-based frozen composition.

16. The process of claim 15, wherein the biscuit has a desired shape and a final moisture level of between 1 and 5%.

17. A composite frozen confectionery product made by the process of claim 14.
